(19) United States
(12) Patent Application Publication
(10) Pub. No.: US 2008/0281558 A1
(43) Pub. Date: Nov. 13, 2008

(54) Methods and Systems for Self-Improvement

(76) Inventors: Donald Spector, New York, NY (US); Barbara E. Carver, New York, NY (US)

Correspondence Address: DIEHL SERVILLA LLC, 77 BRANT AVE, SUITE 210, CLARK, NJ, 07066, US

(21) Appl. No.: 12/177,921

(22) Filed: Jul. 23, 2008

Related U.S. Application Data
(63) Continuation-in-part of application No. 11/366,731, filed on Mar. 2, 2006.

(51) Int. Cl. G06F 17/18; G09B 7/00

(52) U.S. Cl. 702/182; 434/236; 434/322

(57) ABSTRACT

A system and method of assessing an individual's chance for success is disclosed. The method includes taking a test, the test including questions that measure a plurality of characteristics of the individual. A score associated with each of the measured plurality of characteristics of the individual in accordance with the pre-selected field is weighted. Then a final score is determined from the weighted scores, the score being indicative of the chance for success in the pre-selected field. A movie representing an individual's progress may be generated.

### CROSS-REFERENCE TO RELATED APPLICATIONS

This application is a continuation-in-part, and claims the benefit under 35 U.S.C. § 120 of U.S. application Ser. No. 11/366,731, filed Mar. 2, 2006, which is incorporated herein by reference in its entirety.

### BACKGROUND OF THE INVENTION

This patent relates to an area of self-improvement assessment. It provides methods and systems for self-improvement.

There are many people that have never been taught skills needed for success in today's world. This is true whether that success is measured in monetary terms or in terms of personal satisfaction. These individuals would derive tremendous benefit from self-improvement curriculums that teach some of the skills needed for success. The individuals who would benefit from such curriculums range from those individuals who have never really entered the job market and whose self-esteem is non-existent to those individuals who have steadily climbed the ladder but are missing a key ingredient to climb to the next rung on the ladder.

An integral part of such a self-improvement curriculum should be a system and method for measuring and determining the amount of improvement. Such a system should allow individuals taking courses in the curriculum to determine their self-improvement, but should also allow third parties, such as a school or an employer, to determine the level of improvement.

Accordingly, new and improved self-improvement curriculums, as well as systems and methods for assessing progress and improvement that result from taking courses in the self-improvement curriculums, are needed.

### SUMMARY OF THE INVENTION

Unlike regular assessments, the model of the present invention breaks out factors that can lead to success into its most elementary formats or the molecules of success. Hundreds of factors in which people make instant judgments are defined and weighted. If someone were to score a zero on this test, the chances of success would be virtually impossible, conversely a score of 100 would ALMOST make it impossible for that person not to succeed. There is always an element of chance. A person with no ability or a zero score could possible inherit money or win a lottery ticket. These scales are based on what we believe is the probability of success, which raises with a high number and drops with a small number.

Unlike other self-help assessments and books, the molecular model of the present invention is unique in that it can give a person instant things that the person can do to improve their score, and while success may be measurable over a longer period of time, the individual components can be used to give a higher score that will ultimately improve the chance for success.

Therefore, teeth whitening might be very low on the scale, but it can in a small bit raise your score. This coupled with improving attire and working on speech, can give a person enough to possibly succeed at a job interview (all other factors being equal).

For instance, in one example a successful waiter may be expected to have some good inter-personal and social skills, dress appropriately and have an ability to remember a plurality of orders. A sales person in a pet store also requires inter-personal skills. However, those interpersonal skills may be different from those of a waiter. A sales person in a pet store will also need to have some knowledge of animals and animal products and perhaps have a skill of handling animals.

In another example, a successful military general may be expected to have good leadership abilities. Whereas leadership abilities are not necessary to make one a good fashion model. Although a successful fashion model may have excellent leadership skills, it is not an essential component or characteristic of the field or profession.

What can clearly be seen from the molecular model of success of the present invention is that there are certain factors that cannot be changed. Therefore, a person must work on those factors that can be changed. A person who is short can wear elevated shoes, since it is believed that height (however small or large) is a factor in success. Also these factors and scales can change based on a person's objectives. A model has a lower weighting for intelligence than a physics professor. Conversely, looks would have a very high rating for the model. It is interesting to note that when talking pictures came in, a lot of silent stars immediately faded because a major new factor was introduced. Conversely, Richard Burton may not have had the molecules for success in the silent age. It is interesting to note that some did make the transition since there are factors beyond the most obvious that include drive, ambition, personality, the undefined charisma, etc.

In accordance with one aspect of the present invention, a method of assessing an individual's chance for success in a pre-selected field includes taking a test that includes questions that measure a plurality of characteristics of the individual, weighting a score associated with each of the measured plurality of characteristics of the individual in accordance with the pre-selected field, and determining a final score from the weighted scores, the score being indicative of the chance for success in the pre-selected field. In accordance with a further aspect of the present invention, the plurality of characteristics of the individual includes one or more physical characteristics of the individual, one or more mental characteristics of the individual and one or more emotional characteristics of the individual.

The method of the present invention can further include determining and weighting a score based on the one or more physical characteristics, determining and weighting a score based on the one or more mental characteristics, determining and weighting a score based on the one or more emotional characteristics and determining the final score from the weighted score based on physical characteristics, the weighted score from the mental characteristics and the weighted score from the emotional characteristics.

The weights used during the weighting steps are determined in accordance with the pre-selected field.

In accordance with a further aspect of the present invention, a self-improvement plan is developed on a computer based on the score associated with each of the measured plurality of characteristics of the individual in accordance with the pre-selected field and on the final score.

The present invention also includes a system of assessing an individual's chance for success in a pre-selected field. The system includes a network, a client computer connected to the network, and a server connected to the network.

Each of the client processors includes computer readable code capable of: providing a test that includes questions that measure a plurality of characteristics of the individual and sending the results of the test to the network. The test itself may reside on the client computer and be run on command from a user, or the test may reside on the server and be downloaded to the client computer on command from a user.

The server receives the results of the test over the network. The server includes computer readable code capable of: weighting a score associated with each of the measured plurality of characteristics of the individual in accordance with the pre-selected field and determining a final score from the weighted scores, the score being indicative of the chance for success in the pre-selected field.

The system can also be implemented on a stand-alone personal computer or other type of computing device such as a personal digital assistant. In this case, the functions implemented by the server and the client computer are combined into computer readable code on the personal computer.

### DESCRIPTION OF THE DRAWINGS

FIG. 1 illustrates a process in accordance with one aspect of the present invention;

FIG. 2 illustrates a process in accordance with another aspect of the present invention;

FIG. 3 illustrates a self-improvement program generated by the system of the present invention;

FIG. 4 illustrates a system in accordance with a further aspect of the present invention;

FIGS. 5 to 8 illustrate several images from an example movie according to one or more aspects of the invention; and

FIG. 9 illustrates an example system according to one or more embodiments of the invention.

### DESCRIPTION OF A PREFERRED EMBODIMENT

The present invention provides methods and systems for assessing the chance of an individual succeeding in a selected field and for providing a self-improvement plan or plans to the assessed individual.

As used in this specification and the appended claims, the singular forms “a”, “an” and “the” include plural referents unless the context clearly indicates otherwise. Thus, for example, reference to “a characteristic” includes a mixture of two or more characteristics, and the like.

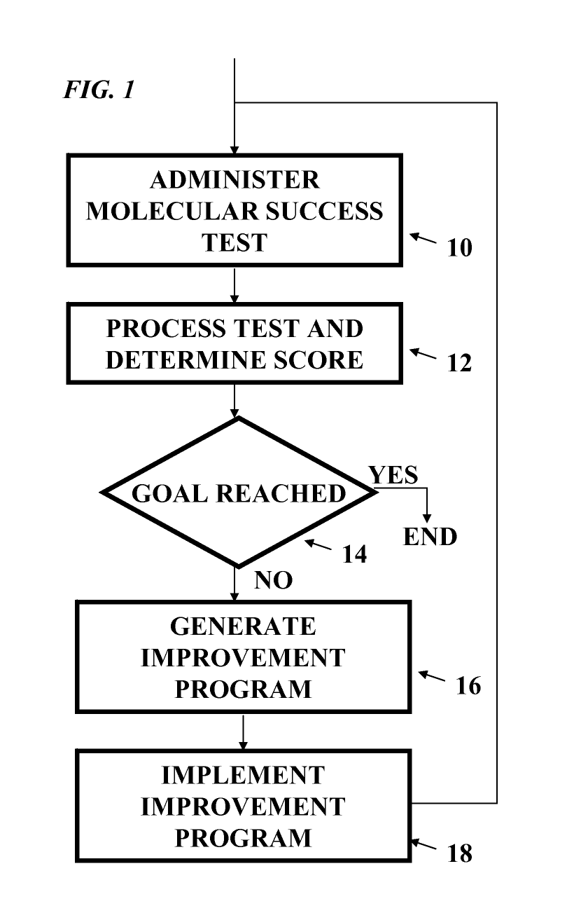

FIG. 1 illustrates a process in accordance with one aspect of the present invention. In step 10, a molecular success test is administered to a person, as described later. In step 12, the test is evaluated and scored. In step 14, it is determined whether a goal has been reached. If this is the first time taking the test, this step is skipped. If the goal has been reached, then the process stops. If the goal has not been reached, then in step 16, an improvement program is generated. In step 18, the improvement program is implemented and eventually the user retakes the test, receives a new score and determines whether the goal has been met.

A number of physical, mental and emotional factors are preferably included in the model or the molecular stress test. The following list includes a template to illustrate the methods and the systems of the present invention, but is not meant to limit the model. The lists will be defined using psychologists, psychiatrists, human resource professionals, executives and others, along with rating scales based on a person's objectives. It is believed that this novel scale is a unique way of visualizing the area.

Examples of the Molecular Success Traits, used in accordance with one aspect of the present invention, are set forth below in Tables 1, 2 and 3 below. Table 1 is illustrative of the physical parameters used in accordance with one aspect of the present invention.

TABLE 1
Physical Parameters
Physical

```
Weight
Height
Torso shape
Face shape
Ears and nose size
Head size
Hair style
Hair length
Hair color
Comb-over
Facial Hair
Color of Eyes
Shape of eyes
Appearance
Skin condition
Facial imperfections
Make-up
Five o'clock shadow
Tan
Body odor
Fragrance
Dress
Fashion sense
Use of color
Fashion color
Fashion fit
Clothing neatness/cleanliness
Appropriate clothing/dress for situation
Appropriate fit
Shoes
Personal accessories
Jewelry/watch
Business accessories
  Briefcase
  Pen
Best colors for skin and hair tone
Tooth health
Breath
Teeth whiteness
Smile
Best smile
Best profile
Hands - size and skin
Nails well groomed
Bitten nails
Speech (articulation)
Speech (modulation)
Grammar
Vocabulary
Listening skills
Eye contact
Firm Handshake
Mannerisms
Manners
  Business
  Personal
Sex Appeal
Physical Fitness
Controlled Breathing
Toned
Health
Dependence on medication
Use of vitamins and supplements
Appearance of Health
Financial Stability
Cultural Background
Educational Background
Previous work experience
Wearing Glasses
Style of glasses
Stride
Walking rhythm
Ability to cut across religious backgrounds
Race
Creed
Diet
Nutrition
Alcohol usage
Drug usage
Smoking
Posture
Sitting position
Foot position
Leg crossing
First impression on others
“Tells” - nervous habits
Strength
  Physical
  Speech
Note taker
Book reader
Legible handwriting
Moist skin
Photogenic
Ability with electronics
Phone manner
Gum chewing
Email style
Business presentation skills
Public speaking skills/style
Swearing
Racial/ethnic slurs
Eating habits
      mouth closed
      speaking while eating
      nibbling with fingers
      slurping
      eating off of other people's plates
      holding/using utensils properly
Athleticism
Stamina
```

Table 2 is illustrative of the mental parameters used in accordance with one aspect of the present invention.

TABLE 2
Mental Parameters
Mental

Attitude (Broken down into several divisions)
Leader or Follower
Ambition
Confidence (self Image)
Poise
Personality
Knowledge Base
Book smarts
Street smarts
Nimbleness - can think on your feet
Charisma
Believability
Ability to relate to others at different levels
Ability to make small talk
Having friends of all ages/from different backgrounds
Ability to remember others' names
Honesty
Perception of Honesty
Perception of Humility
Humility
Religion
Special Experiences
Intelligence
Educational Base
Specific Subjects
Knowledge of current events
Forgetfulness
Truthfulness
Forgiving
Inquisitive
Conviction
Creative
Open to new ideas
Open to new people
Open to new adventures
Ability to problem solve
Meditation
Focus
Concentration
Good listener
Resolute
Persistent
Sense of Adventure
Flair
Uniqueness
Curiosity
Drive
Determination
Motivation
Grace
Steadfastness
Obstinacy
Stubbornness
Courage
Valor
Generosity
Kindness
Promptness
Simple math - addition, subtraction, percentages
Tipping skills
Reading skills
Reading comprehension
Reading out loud
Consideration of others
Strength of character
Cool under pressure
Cultural
Multi-lingual
Money management
Credit rating
Reaction to wealth
Reaction to poverty
Thoughtfulness
Sense of humor
Ability to tell a joke/funny story
Wittiness
Patience
Prejudice
Tolerance of women (or opposite sex)
Equality for women
Tolerance of same sex (not feeling threatened)
Tolerance of sexual preference other than your own
Laziness
Procrastination
Charitable
Sexual

Table 3 is illustrative of the emotional parameters used in accordance with one aspect of the present invention.

TABLE 3
Emotional Parameters
Emotional

Vulnerability
Sensitivity
Mechanisms of Coping (knowledge of Meditation, etc.)
Tolerance of foreigners
Tolerance of minorities
Warmth
Hospitable
Empathetic
Sympathetic
Nervousness
Anxiety
Depression
Comforting
Tolerant
Happiness
Anger Control
Love of family
Love of children
Love of pets/animals
Love of music
Love of dance
Jealousy
Passion
Desire
Shyness
Calm
Free-spirited
Arrogance
Overly-excitable
Envy
Love of work (workaholic)
Love of life
Need to consume (“Must have it”)
Lust
Pride
Tender
Sensual
Ability to honestly self-evaluate
Control of risk taking/gambling-not compulsive
Tolerance of non-traditional sexuality
Tolerance of imperfection in others
Tolerance of imperfection in self
Ability to apologize
Fanatical belief
Ability to defer short term pleasure for greater long term benefits
(invest)

The molecular success test can be self-administered. In this embodiment, the user answers the questions based on their self-assessment. The test can also be implemented by a third party who asks the user questions and enters results based on their interpretation of the user's answers.

The user typically selects a field that they are interested in. As used in this specification and the appended claims, the term “field” refers to any area of activity, interest, subject, area of academic interest, area of specialization, profession, employment or business. The characteristics included in the test, including the physical characteristics, the mental characteristics and the emotional characteristics, can be selected in accordance with the selected field. Thus, one set of characteristics may be deemed important to one field, but not important to another field.

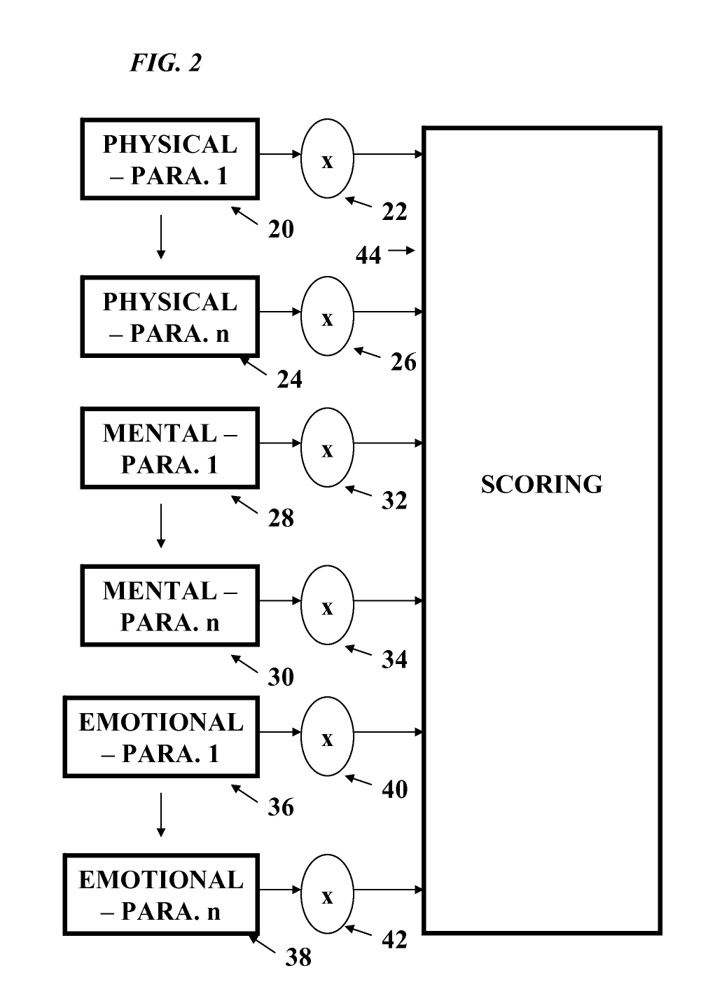

FIG. 2 illustrates the processing of the test to determine a score in accordance with one aspect of the present invention. In steps 20 to 22, the scores associated with the physical characteristics are determined. In steps 24 to 26, these scores are weighted. In steps 28 to 30, the scores associated with the mental characteristics are determined. In steps 32 to 34, these scores are weighted. In steps 36 to 38, the scores associated with the emotional characteristics are determined. In steps 40 to 42, these scores are weighted. In step 44, the weighted scores are input to a processor and a final score determined. The final score can be a simple addition of the weighted scores or any other approach. The weightings used can be any number, including 0 if it is desired to ignore a parameter.

The scores from each of the three main characteristics—physical, mental and emotional—can be summed or processed in any desired way and the weighting can be applied to each score. Then a final score is determined from the weighted physical, mental and emotional scores.

The weightings used can vary depending on the field selected by a user. Thus, a parameter for a model would be weighted differently than a parameter for a lawyer.

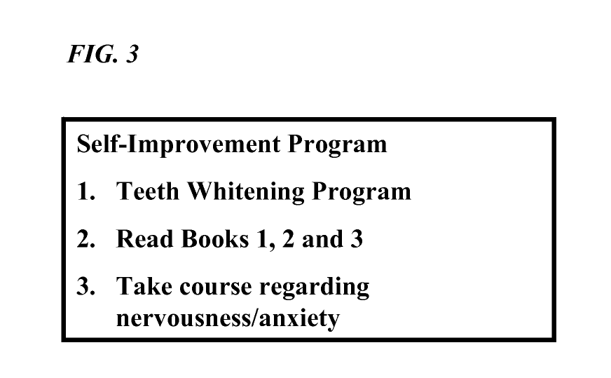

FIG. 3 illustrates a self-improvement plan developed in accordance with a test taken. The self-improvement plan has specific tasks to be accomplished by a user to improve the score on the molecular success test. These tasks are preferably tailored in accordance with the results on the test and with the field selected by the user. Thus, a person that desires to be a model would be given different tasks to work on than a future lawyer. The tasks included in the self-improvement plan are prioritized in accordance with those parameters that will best improve the score. New tasks are included in the self-improvement plan with every round that the molecular success test is taken.

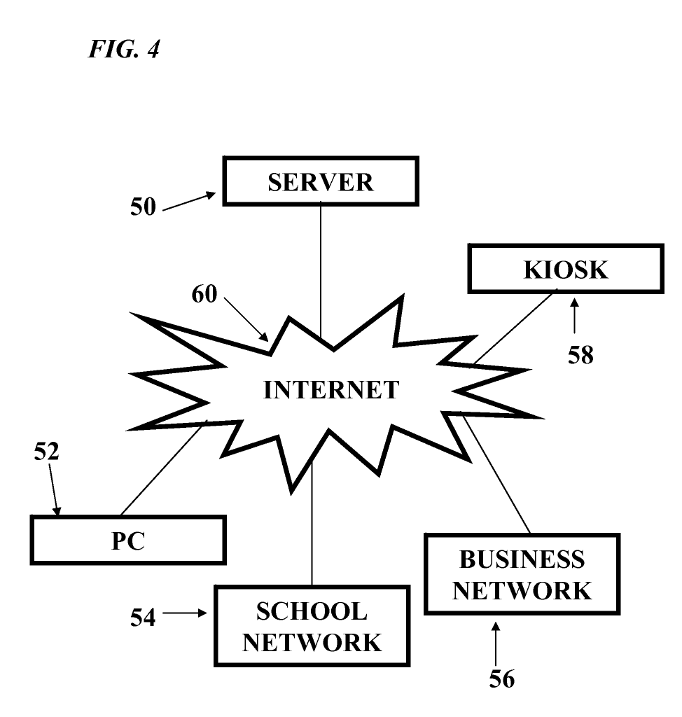

FIG. 4 illustrates a system in accordance with an aspect of the present invention. A server 50 communicates with client computers 52, 54, 56 and 58 via a network 60. The network 60 is preferably the Internet. The computer 52 is a personal computer that can, for example, be located in a person's home or place of business. The computer 54 can be a plurality of computers on a school network. The school can offer students a self-improvement program. The computer 56 can be a plurality of computers on a business network. The business, in accordance with one aspect of the present invention, can offer a self-improvement program to its employees. The computer 58 can be in a stand-alone kiosk place in any public place.

In accordance with one aspect of the present invention, the client processors 52, 54, 56 and 58 have computer readable code capable of: providing a test that includes questions that measure a plurality of characteristics of the individual and sending the results of the test to the network. The test may be resident on the client computer or downloaded from the server 50. The server 50 receives the results of the test over the network and has computer readable code capable of: weighting a score associated with each of the measured plurality of characteristics of the individual in accordance with the pre-selected field and determining a final score from the weighted scores, the score being indicative of the chance for success in the pre-selected field.

The server 50 determines the score in accordance with any of the various weighting approaches described herein. The server 50 also generates the improvement program described generally in FIG. 3.

The system and process of the present invention can also be implemented in a stand-alone personal computer or any other type of computer. In this case, the computer code that implements all of these functions is located on one computer.

It is a further aspect of the present invention to provide a method that displays the progress of a participant in, for instance, a self-improvement program or course. It is important for a participant in a self improvement program to be able to view the progress being made in the program. It is also important for mentors or counselors or teachers to view the progress being made.

The capability to view a progress report is important as a motivator. It is also important as feedback to identify areas of attention for further efforts or focus when there are aspects where a participant is lagging in making progress.

While progress in a course in an academic subject can be relatively easily tested on a regular basis, progress in appearance and emotional attitude are relatively difficult to quantify or even to test.

It is therefore an aspect of the present invention to create and to conduct a course for an individual who wants to improve him or herself. Courses may be given online or in person. The course may focus on improving physical, emotional or mental personal characteristics. The characteristics may also involve academic or cognitive aspects; for example, memorizing a speech involving data or a joke. It is a further aspect of the present invention to test the progress of a participant on a regular basis and to record their progress. It is further an aspect of the present invention to provide feedback to a participant on progress made.

For instance, an improvement course may involve personal appearance, like whitening of teeth, combined with improving posture sitting on a chair or standing up.

These aspects may not be trivial to achieve for a person who had never had positive feedback or who has a low self esteem. Providing feedback on a regular basis is very important. Feedback in numbers, for instance, scoring by a counselor on a scale of 1 to 10, may be somewhat helpful. However, it may also lack effectiveness in motivating some participants in an improvement course.

A course may comprise tasks and exercises for the participant. The course may involve brushing teeth with a special whitening tooth paste on a regular basis as well as avoiding certain habits and foods. For posture, the course may have physical exercises as well as exercises for a person to project a certain conviction and determination.

It should be appreciated that providing feedback in a numerical score in those cases may not be effective. It is therefore an aspect of the present invention to test the progress by recording the state of affairs on a regular basis, including a beginning state when the participant starts a course. The recording may be recording a video recording for a certain time, recording speech, providing a numerical score, or scoring questions on an interview.

A series of video recording may be combined over a period of 2 months for example, where a recording of at least 15 seconds was obtained each week. A combined recording of 1 minute may be shown after a month, and a combined recording of 2 minutes after 2 months. A counselor may point out where progress was made and where progress was lagging. One may make sure that such recordings have a similar setting so that differences between the recordings can easily be distinguished. It may be possible to insert in a recording certain artifacts that can help identify progress. A white bar may serve as a standard for whiteness to measure against. A line drawn inserted and overlaid on a recording may provide a measure for slouching or posture. The recordings may, of course, also be made with a different frequency depending, for instance, on expected progress or need for feedback. One may make, for instance, recordings every day. The progress can thus be shown as a movie of progress of a participant.

One may take an interview of a course participant on a regular basis. Some of the subjects for interviews were provided earlier herein. One may rate answers to the questions with the ratings being displayed as a graph.

A course participant may draw confidence from opinions from other people like peers, relatives, and friends or from strangers like an unknown or impartial reviewer. It is therefore another aspect of the present invention, wherein one may include an opinion of a person who knows the participant or from a person who does not know the participant as part of a progress report. One may call these opinions outside progress reports. These opinions may be collected through a paper questionnaire or through a computer based interview. The opinions may be collected based on personal contact between a participant and an outside reviewer. It may also be based on review of performance of the participant that was recorded. An opinion of an outside reviewer may be collected on a regular basis. It may be taken at the beginning and/or an ending of a course. It may also be taken on any other time that is deemed relevant for evaluation of the progress of the participant. The opinions may be rated and provided in a graph. Opinions may also be recorded as an audio and/or a video recording.

For instance, at the beginning of a course, one or more outside reviewers may provide a video recorded opinion on certain aspects of a participant. During the course and at the ending of the course the outside reviewers may provide additional opinions reflecting the progress achieved by the participant. Using these opinions and recordings may be at the discretion of a participant's course mentor or teacher to be appropriately used for providing motivation and feedback.

As an example, an individual may follow a course to improve a style of presentation, by speaking more clearly, improving the articulation of an idea, improving posture and dressing better for business occasions. Video recordings can be taken from the individual before and during a course. Friends, acquaintances or teachers can be interviewed and recorded for opinion before, during or at the end of a course. These recordings can be combined into a movie showing actual progress.

The recordings such as video recordings of the opinions may be combined with recordings of the participant, creating a movie that may reflect the progress of the participant throughout the course.

Ratings from questionnaires, opinions and interviews can be put into a graph. The graphs created from the interviews, not unlike video recordings, can also be combined into a movie, showing dynamically the progress being made by a participant in a course.

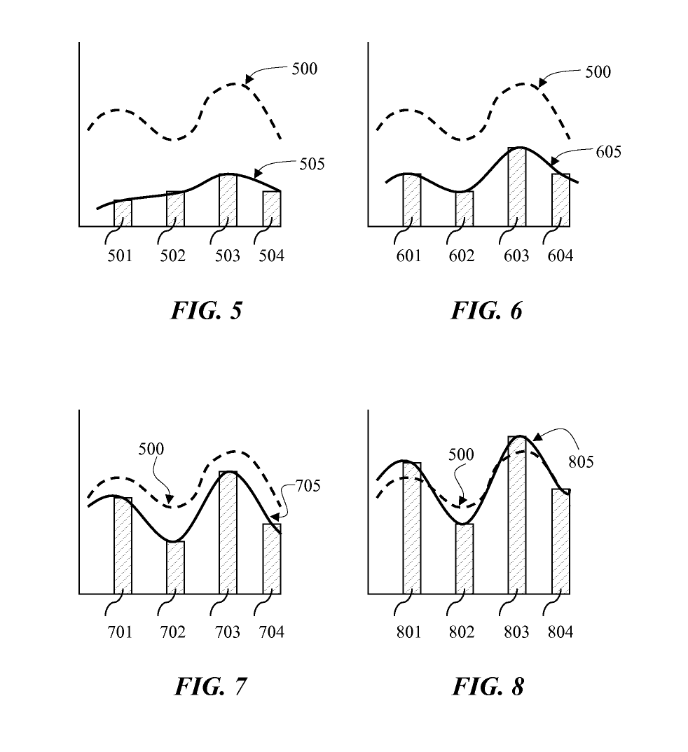

An example is shown in FIGS. 5 through 8. It should be appreciated that many different graphical representations of test results can be created and that these are only examples. FIG. 5 shows a graph on two axes. The vertical axis provides a rating for a test. The horizontal axis identifies different test or interview matters. It can have as many subjects as one requires. However, in this case, the 4 categories: physical, emotional, mental and cognitive characteristics are scored. In the example, 4 graphs are provided in FIGS. 5 through 8 showing test results of 4 different characteristics at 4 different moments in time. The 4 characteristics are identified as 501, 502, 503 and 504 in FIG. 5; as 601, 602, 603 and 604 in FIGS. 6, 701, 702, 703 and 704 in FIG. 7 and as 801, 802, 803 and 804 in FIG. 8. A curve 500 may be provided in FIGS. 5, 6, 7 and 8 representing the goals for a participant. A curve 505 in FIG. 5, a curve 605 in FIG. 6, a curve 705 in FIG. 7 and a curve 805 in FIG. 8 provide a progress curve.

One can then easily show the curves on, for instance a computer screen, how a participant is making progress. It also shows, for instance in FIG. 8, that the participant is exceeding the goals for 3 characteristics but needs extra work on characteristic 804.

One can show, for instance, an actual video of progress as provided earlier and combine it, for instance, with a dynamically changing graph that may be displayed in a synchronous fashion with the video movie and that may highlight points of progress and points needing further attention.

In one embodiment, one can make recordings such as video recordings of a participant over the duration of a course focused on a characteristic for which the participant is seeking improvement. One may then later combine the individual recordings to show progress on a specific characteristic over time as well as an overall progress. These recordings may be combined with a graphical presentation of progress on individual characteristics. One may also provide a movie or a segment of a movie showing an overall or integrated progress made by the participant.

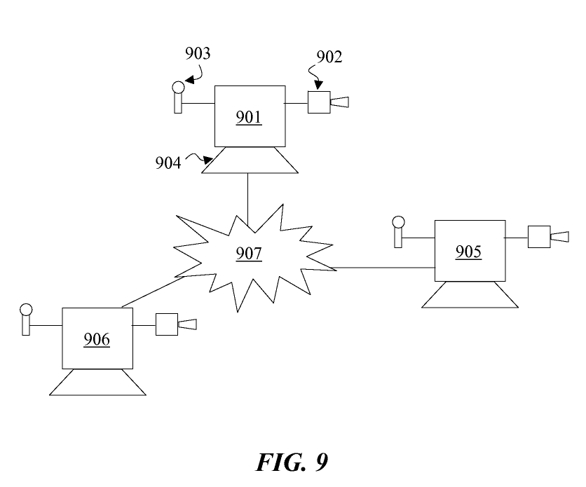

A possible embodiment for conducting a self-improvement course on-line with feedback from a teacher and from outside reviewers is shown in FIG. 9. Computer systems 901, 905 and 906 are connected to a network 907 which may be the Internet. Each system may have components like a video camera 902, a microphone for sound recording 903 and input/control device 904 which may include a keyboard and a mouse. Each computer 901, 905 and 906 represent a different role. Computer 901 represents a course participant. Computer 905 represents a course provider. The course provider may include a teacher, or it may be a computer program that provides pre-programmed teaching instructions to a participant and also has capability for performing an evaluation program. System 906 may represent an outside reviewer. An outside reviewer may be provided or assigned by the course provider; a reviewer may also be provided by the participant.

As part of a course, the participant may provide initial information and an example of his/her presentation skills. The computer 901 may ask either through a person or a program from a participant at computer 905 to answer a question, to provide a presentation or any other action that may be recorded, including video recording. Such a record may be then be provided by computer 901 to computer 905 for evaluation.

A reviewer at computer 906 may be requested to provide an opinion on a participant. This opinion may be based on, for instance, information including a recorded performance of the participant provided to computer 906 by computer 905. The opinion provided by the reviewer may also be recorded and provided to, for instance, computer 905.

The recorded performance of a participant and one or more recorded opinions of a reviewer may be included in a rating for a participant. Such a rating of a participant may be presented as a movie. Numerical ratings of a participant may also be included in a feedback to a participant. Numerical ratings may be provided in the form of a graph.

A progress movie, or progress report, may be presented as an intermediate or as an end result to a participant. It may also be used to recommend additional or more focused courses. It may also be used to have a participant qualify as having achieved a certain level in certain characteristics.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method of assessing an individual, comprising:
selecting a field from a preselected list of fields;
taking a test, the test comprising questions that measure a plurality of characteristics of the individual;
making a recording reflecting at least one characteristic of the individual;
weighting a score associated with each of the measured plurality of characteristics of the individual;
determining a final score from the weighted scores, the score being indicative of the chance for success; and
providing a movie representing an assessment of the individual in the measured characteristics.

2. The method of claim 1, wherein the recording is a video recording and the movie comprises a video recording.

3. The method of claim 1, wherein the movie comprises a graphical presentation of the weighted scores.

4. The method of claim 1, comprising selecting a field and weighting the score associated with each of the measured plurality of characteristics in accordance with the field, wherein the final score is indicative of the chance for success in the field.

5. The method of claim 1, wherein the plurality of characteristics of the individual includes one or more physical characteristics of the individual, one or more mental characteristics of the individual and one or more emotional characteristics of the individual.

6. The method of claim 5, further comprising:
determining and weighting a score based on the one or more physical characteristics;
determining and weighting a score based on the one or more mental characteristics;
determining and weighting a score based on the one or more emotional characteristics;
determining the final score from the weighted score based on physical characteristics, the weighted score from the mental characteristics and the weighted score from the emotional characteristics.

7. The method of claim 1, further comprising developing a self-improvement plan on a computer based on the score associated with each of the measured plurality of characteristics of the individual in accordance with the pre-selected field and on the final score.

8. The method of claim 5, further comprising developing a self-improvement plan on a computer based on the score associated with the plurality of characteristics of the individual including one or more physical characteristics of the individual, one or more mental characteristics of the individual and one or more emotional characteristics of the individual and on the final score.

9. The method of claim 8, further comprising:
following a course implementing the self-improvement plan;
retaking the test by the individual after following at least part of the course;
making a new recording of the individual after following at least part of the course reflecting changes to a characteristic of the individual.

10. The method as claimed in claim 9, wherein the recording is a video recording and the movie comprises a video recording.

11. The method as claimed in claim 9, wherein the movie comprises a graphical presentation of the weighted scores.

12. The method as claimed in claim 9, wherein the recording of the individual focuses on one of the plurality of characteristics of the individual.

13. The method as claimed in claim 9, wherein the movie has a segment representing one of the plurality of characteristics.

14. The method as claimed in claim 9, wherein the movie provides a plurality of segments, each segment representing one of the plurality of characteristics.

15. A system of assessing an individual, comprising:
a network
a client computer connected to the network, each of the client processors having computer readable code capable of:
providing a test that includes questions that measure a plurality of characteristics of the individual;
sending the results of the test to the network; and
a server connected to the network that receives the results of the test over the network, the server having computer readable code capable of:
weighting a score associated with each of the measured plurality of characteristics of the individual; and
determining a final score from the weighted scores, the score being indicative of the chance for success.

16. The system of claim 15, wherein the computer readable code on the client computer is capable of allowing a user to select a field and of weighting the score associated with each of the measured plurality of characteristics in accordance with the field, wherein the final score is indicative of the chance for success in the field.

17. The system of claim 15, wherein the plurality of characteristics of the individual includes one or more physical characteristics of the individual, one or more mental characteristics of the individual and one or more emotional characteristics of the individual.

18. The system of claim 17, wherein the computer readable code is the server is further capable of:
determining and weighting a score based on the one or more physical characteristics;
determining and weighting a score based on the one or more mental characteristics;
determining and weighting a score based on the one or more emotional characteristics;
determining the final score from the weighted score based on physical characteristics, the weighted score from the mental characteristics and the weighted score from the emotional characteristics.

19. The system of claim 15, wherein the computer readable code on the server is further capable of developing a self-improvement plan on a computer based on the score associated with each of the measured plurality of characteristics of the individual in accordance with the pre-selected field and on the final score.

20. The system of claim 17, wherein the computer readable code of the server is further capable of developing a self-improvement plan on a computer based on the score associated with the plurality of characteristics of the individual including one or more physical characteristics of the individual, one or more mental characteristics of the individual and one or more emotional characteristics of the individual and on the final score.
